(19) United States
(12) Patent Application Publication
(10) Pub. No.: US 2021/0051541 A1
(43) Pub. Date: Feb. 18, 2021

(54) METHOD AND DEVICE FOR SERVICE PROCESSING IN HANDOVER PROCEDURE, TERMINAL AND NETWORK DEVICE

(71) Applicant: GUANGDONG OPPO MOBILE TELECOMMUNICATIONS CORP., LTD., Dongguan (CN)

(72) Inventors: Jianhua LIU, Dongguan (CN); Ning Yang, Dongguan (CN)

(73) Assignee: GUANGDONG OPPO MOBILE TELECOMMUNICATIONS CORP., LTD., Dongguan (CN)

(21) Appl. No.: 17/088,200

(22) Filed: Nov. 3, 2020

Related U.S. Application Data
(63) Continuation of application No. PCT/CN2019/084307, filed on Apr. 25, 2019.
(60) Provisional application No. 62/667,498, filed on May 5, 2018.

(51) Int. Cl. H04W 36/00

(52) U.S. Cl. CPC H04W 36/0077; H04W 36/0058; H04W 36/0079; H04W 36/0061

(57) ABSTRACT

A method for service processing in a handover procedure is provided, including that: a source RAN node acquires service information of a first service, the first service being a service initiated by a terminal via the source RAN node; the source RAN node determines a target RAN node, and transmits a handover request message to the target RAN node, the handover request message carrying the service information of the first service, and the service information of the first service being configured for the target RAN node to determine whether the first service is supported.

### CROSS-REFERENCE TO RELATED APPLICATIONS

This is a continuation application of International Patent Application No. PCT/CN2019/084307, fled on Apr. 25, 2019, which claims priority to American Provisional Application No. 62/667,498, entitled “Mechanism service supporting handover procedure”, filed on May 5, 2018, the entire contents of which are incorporated herein by reference in their entirety.

### BACKGROUND

In the existing 3rd Generation Partnership Project (3GPP) specifications, there is no service based a handover procedure. When User Equipment (UE) moves from one Radio Access Network (RAN) node to another RAN node, the target RAN node may not support an ongoing service of the UE, which results in handover failure, and the ongoing service will be broken.

### SUMMARY

The disclosure relates to the field of mobile communications, and more particularly to a method and device for service processing in a handover procedure, a terminal and a network device.

According to a first aspect, the disclosure provides a method for service processing in a handover procedure, which may include the following operations. A source Radio Access Network (RAN) node acquires service information of a first service, wherein the first service is a service initiated by a terminal via the source RAN node. The source RAN node determines a target RAN node, and transmits a handover request message to the target RAN node. The handover request message carries the service information of the first service, and the service information of the first service is configured for the target RAN node to determine whether the first service is supported.

According to a second aspect, the disclosure provides a method for service processing in a handover procedure, which may include the following operations. A terminal determines a target cell whether to support a first service, wherein the first service is a service initiated by the terminal via a source RAN node. In condition that the first service is supported by the target cell, the terminal transmits a first measurement report, and the first measurement report carries a measurement result of the target cell to the source RAN node. In condition that the first service is unsupported by the target cell, the terminal transmits a second measurement report to the source RAN node, and the second measurement report does not carry the measurement result of the target cell.

According to a third aspect, the disclosure provides a device for service processing in a handover procedure, which may include an acquisition unit, a determination unit and a transmitting unit. The acquisition unit is configured to acquire service information of a first service, wherein the first service is a service initiated by a terminal via a source RAN node. The determination unit is configured to determine a target RAN node. The transmitting unit is configured to transmit a handover request message to the target RAN node. The handover request message carries the service information of the first service, and the service information of the first service is configured for the target RAN node to determine whether the first service is supported.

According to a fourth aspect, the disclosure provides a device for service processing in a handover procedure, which may include a determination unit and a transmitting unit. The determination unit is configured to determine a target cell whether to support a first service, wherein the first service is a service initiated by the terminal via a source RAN node. The transmitting unit is configured to transmit, in condition that the first service is supported by the target cell, a first measurement report to the source RAN node, the first measurement report carrying a measurement result of the target cell, and transmit, in condition that the first service is unsupported by the target cell, a second measurement report to the source RAN node, the second measurement report not carrying the measurement result of the target cell.

According to a fifth aspect, the disclosure provides a terminal, which may include a memory and a processor. The memory stores one or more computer programs. The processor is configured to call and execute the one or more computer programs in the memory to execute the method for service processing in a handover procedure according to the first aspect.

According to a sixth aspect, the disclosure provides a network device, which may include a memory and a processor. The memory stores one or more computer programs. The processor is configured to call and execute the one or more computer programs in the memory to execute the method for service processing in a handover procedure according to the second aspect.

According to a seventh aspect, the disclosure provides a chip, configured to implement the method for service processing in a handover procedure according to the first aspect or the second aspect. Specifically, the chip may include a processor. The processor is configured to call and execute one or more computer programs in a memory, to cause a device configured with the chip to execute the method for service processing in a handover procedure according to the first aspect or the second aspect.

According to an eighth aspect, the disclosure provides a computer-readable storage medium storing one or more computer programs. The computer programs may cause the processor to execute the method for service processing in a handover procedure according to the first aspect or the second aspect.

According to a ninth aspect, the disclosure provides a computer program product including computer program instructions. The computer program instructions may cause the processor to execute the method for service processing in a handover procedure according to the first aspect or the second aspect.

According to a tenth aspect, the disclosure provides a computer program. The computer program, when executed by a processor, causes the processor to execute the method for service processing in a handover procedure according to the first aspect or the second aspect.

According to the above technical solutions of the disclosure, the source RAN node transmits service information of the service initiated by the terminal at the source RAN node side to the target RAN node through the handover request message.

Therefore, the target RAN node can determine how to respond to the handover request message from the source RAN node according to the service capability supported by the target RAN node, thereby avoiding the handover failure due to the condition that the server initiated by the terminal at the source RAN node side is unsupported by the target RAN node, and further avoiding break of the service.

### BRIEF DESCRIPTION OF DRAWINGS

The accompanying drawings described herein which are incorporated into and form a part of the disclosure are provided for the better understanding of the disclosure, and exemplary embodiments of the disclosure and description thereof serve to illustrate the disclosure but are not to be construed as improper limitations to the disclosure. In the accompanying drawings:

FIG. 1 is a schematic diagram of a communication system architecture according to an embodiment of the disclosure.

FIG. 2 is a schematic flowchart 1 of a method for service processing in a handover procedure according to an embodiment of the disclosure.

FIG. 3 is a schematic flowchart 2 of a method for service processing in a handover procedure according to an embodiment of the disclosure.

FIG. 4 is a schematic structure diagram 1 of a device for service processing in a handover procedure according to an embodiment of the disclosure.

FIG. 5 is a schematic structure diagram 2 of a device for service processing in a handover procedure according to an embodiment of the disclosure.

FIG. 6 is a schematic structure diagram of a communication device according to an embodiment of the disclosure.

FIG. 7 is a schematic structure diagram of a chip according to an embodiment of the disclosure.

FIG. 8 is a schematic structure diagram of a communication system according to an embodiment of the disclosure.

### DETAILED DESCRIPTION

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

The technical solutions in the embodiments of the disclosure may be applied for various communication systems, such as, a Global System of Mobile Communication (GSM), a Code Division Multiple Access (CDMA) system, a Wideband Code Division Multiple Access (WCDMA) system, a General Packet Radio Service (GPRS) system, a Long Term Evolution (LTE) system, an LTE Frequency Division Duplex (FDD) system, an LTE Time Division Duplex (TDD) system, a Universal Mobile Telecommunication System (UMTS), a Worldwide Interoperability for Microwave Access (WiMAX) communication system, a future 5G communication system and the like.

FIG. 1 illustrates a communication system 100. The communication system 100 is merely a communication system example to which the embodiments of the disclosure are applied. The communication system 100 may include a network device 110. The network device 110 may be a device that communicates with a terminal device 120 (or called a communication terminal, a mobile terminal). The network device 110 may provide communication coverage for a specific geographical area, and may communicate with a terminal in the coverage. In at least one embodiment, the network device 100 may be a Base Transceiver Station (BTS) in a GSM or CDMA system, may also be a NodeB (NB) in a WCDMA system, may further be an Evolutional NodeB (eNB or eNodeB) in an LTE system, or a wireless controller in a Cloud Radio Access Network (CRAN); or the network device may be a mobile switching center (MSC), a relay station, an access point, a vehicle-mounted device, a wearable device, a hub, a switch, a bridge, a router, a network-side device in a future 5G network, a network device in a future evolutional Public Land Mobile Network (PLMN) or the like.

The communication system 100 may further include at least one terminal 120 located within the coverage of the network device 110. “Terminal” used herein includes, but not limited to, a device for communication via a wired connection, such as a Public Switched Telephone Networks (PSTN), a Digital Subscriber Line (DSL), a digital cable, a direct cable connection, and/or via another data connection/network, and/or via a wireless interface, such as for a cellular network, a Wireless Local Area Network (WLAN), a digital television network such as a Digital Video Broadcasting Handheld (DVB-H) network, a satellite network, an AM-FM broadcast transmitter, and/or via a device for receiving/transmitting a communication signal of another terminal, and/or via an Internet of Things (IoT) device. A terminal for communication via a wireless interface may be referred to as a “wireless communication terminal”, “wireless terminal”, or “mobile terminal”. An example of a mobile terminal may include, but not limited to, a satellite or cellular telephone, a personal communication system (PCS) terminal that can combine cellular radiotelephone with data processing, fax, and data communication capabilities, a Personal Digital Assistant (PDA) that includes a radiotelephone, a pager, an internet/Intranet access, a web browser, a memo pad, a calendar, and/or a Global Positioning System (GPS) receiver, and a conventional laptop and/or palmtop receiver or another electronic device including a radiotelephone transceiver. The terminal device may be an access terminal. User Equipment (E), a user unit, a user station, a mobile station, a mobile radio station, a remote station, a remote terminal, a mobile device, a user terminal, a terminal, a wireless communication device, a user agent or a user device. The access terminal may be a cellular phone, a cordless telephone, a Session Initiation Protocol (SIP) phone, a Wireless Local Loop (WLL) station, a PDA, a handheld device having a wireless communication function, a computing device or other processing devices connected to a wireless modem, a vehicle-mounted device, a wearable device, a terminal device in a future 5G network, a terminal device in a future evolved PLMN or the like.

In at least one embodiment, the terminal device 120 may also perform Device to Device (D2D) communication.

In at least one embodiment, the 5G system or 5G network may also be called a New Radio (NR) system or NR network.

FIG. 1 schematically illustrates a network device and two terminals. In at least one embodiment, the communication system 100 may include multiple network devices, and coverage of each network device may include other number of terminal devices, which is not limited in the embodiments of the disclosure.

In at least one embodiment, the communication system 100 may further include a network controller, a mobile management entity and other network entities, which is not limited in the embodiments of the disclosure.

It is to be understood that in the embodiments of the disclosure, a device having a communication function in the network/system may be called a communication device. For example, as for the communication system 100 illustrated in FIG. 1, the communication devices may include the network device 110 and the terminal 120 with the communication function. The network device 110 and the terminal 120 may be specific devices as described above, which will not be elaborated here. The communication devices may also include other devices in the communication system 100, such as a network controller, a mobile management entity or the like, which are not limited in the embodiments of the disclosure.

It is to be understood that terms “system” and “network” in the disclosure may usually be exchanged in the disclosure. In the disclosure, a term “and/or” is only an association relationship describing associated objects and represents that three relationships may exist. For example, A and/or B may represent three conditions: i.e., independent existence of A, existence of both A and B and independent existence of B. In addition, a character “/” in the disclosure usually represents that previous and next associated objects form an “or” relationship.

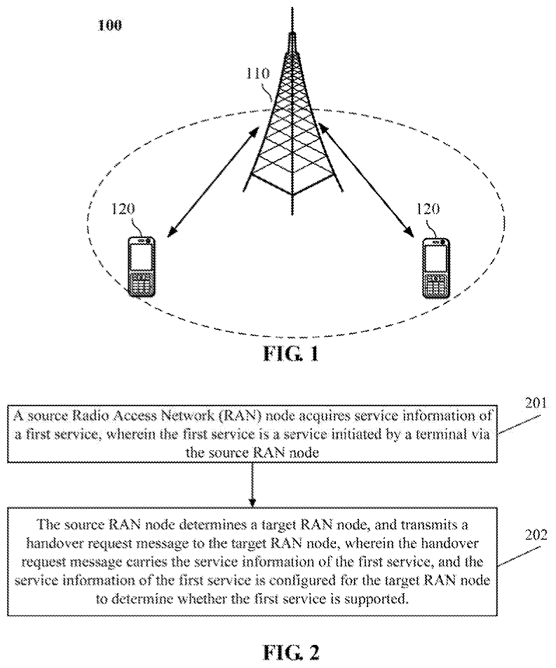

FIG. 2 illustrates a schematic flowchart 1 of a method for service processing in a handover procedure according to an embodiment of the disclosure. As illustrated in FIG. 2, the method for service processing in a handover procedure may include the following operations.

In 201, a source Radio Access Network (RAN) node acquires service information of a first service, wherein the first service is a service initiated by a terminal via the source RAN node.

In the embodiment of the disclosure, the RAN node may also be replaced with a base station or a cell.

In the embodiment of the disclosure, after the terminal accesses the source RAN node, the terminal may initiate the first service at the source RAN node side. The service information of the first service may be a service identifier, a service type and the like. The source RAN node may acquire the service information of the first service in any one of the following modes.

Mode 1: The source RAN node acquires the service information of the first service from a core network node.

Specifically, the source RAN node receives a first request message from the core network node. The first request message carries the service information of the first service, and the first request message is configured to request establishment of a first connection at the source RAN node side for the first service.

Details of Mode 1 may refer to the following description of Embodiment 1.

Mode 2: The source RAN node acquires the service information of the first service from a terminal.

The source RAN node may acquire the service information of the first service from the terminal in any one of the following manners.

1) The source RAN node receives a second request message sent by the terminal. The second request message carries the service information of the first service, and the second request message is configured to request establishment of the first service.

2) The source RAN node receives a measurement report sent by the terminal. The measurement report includes the service information of the first service.

3) The source RAN node configures a service-specific measurement report event for the terminal and receives a service-specific measurement report sent by the terminal. The service-specific measurement report is associated with the first service required to be handed over.

Details of Mode 2 may refer to the following description of Embodiment 2.

In 202, the source RAN node determines a target RAN node, and transmits a handover request message to the target RAN node, wherein the handover request message carries the service information of the first service, and the service information of the first service is configured for the target RAN node to determine whether the first service is supported.

In order to make the technical solutions of the disclosure to be better understood, the handover procedure involved in the disclosure will be described below. The handover procedure includes the following operations. I) When a terminal (such as, UE) moves from the source RAN node to a target RAN node, the terminal will report the measurement report to the source RAN node. II) The source RAN node determines the target RAN node based on the measurement report information. III) The source RAN sends the handover request message to the target RAN node. IV) The target RAN node sends the handover request response message to the source RAN node.

In the embodiment of the disclosure, the source RAN node notifies the service information of the first service to the target RAN node through the handover request message in the operation III). The target RAN node determines whether to the first service is supported according to the service information of the first service.

When the first service is supported by the target RAN node, the source RAN node receives a handover acceptance message from the target RAN node.

When the first service is unsupported by the target RAN node, the source RAN node receives a handover rejection message from the target RAN node. Further, the handover rejection message may carry first indication information for indicating a rejection cause, and the rejection cause is that the first service is unsupported by the target RAN node.

In the embodiment of the disclosure, the source RAN node acquires first information of one or more neighbouring RAN nodes, and the first information is configured to indicate the one or more neighbouring RAN nodes whether to support the first service. The source RAN node determines the neighbouring RAN nodes supporting the first service as candidate target RAN nodes, and selects the target RAN node from the candidate target RAN nodes. Therefore, the target RAN node natively supports the first service, thereby ensuring the success of handover, and further avoiding break of the first service.

FIG. 3 illustrates a schematic flowchart 2 of a method for service processing in a handover procedure according to an embodiment of the disclosure. As illustrated in FIG. 3, the method for service processing in a handover procedure may include the following operations.

In 301, a terminal determines a target cell whether to support a first service, wherein the first service is a service initiated by the terminal via a source RAN node.

In the embodiment of the disclosure, the terminal may be any device capable of communicating with a network, such as a mobile phone, a laptop, a vehicle-mounted terminal, a wearable terminal or the like.

In an implementation, the terminal determines whether the target cell satisfies a measurement event. When determining that the target cell satisfies the measurement event, the terminal determines the target cell whether to support the first service.

In the embodiment of the disclosure, for determining whether the target cell supports the first service, the terminal needs to obtain service capability information of one or more neighboring cells in advance. It is to be noted that the target cell is one of the one or more neighboring cells. Specifically, the terminal may acquire service capability information of the one or more neighboring cells in one of the following manners.

Manner 1: The terminal receives second information from the source RAN node. The second information is configured to indicate the one or more neighbouring cells whether to support the first service, and the one or more neighbouring cells include the target cell. The second information may be carried in a broadcast message or dedicated signaling.

Manner 2: The terminal acquires system information of one or more neighbouring cells, and determines the one or more neighbouring cells whether to support the first service based on the system information of the one or more neighbouring cells. The one or more neighbouring cells include the target cell.

In 302, in condition that the first service is supported by the target cell, the terminal transmits a measurement report carrying a measurement result of the target cell to the source RAN node, and in condition that the first service is unsupported by the target cell, the terminal transmits a measurement report not carrying the measurement result of the target cell to the source RAN node.

Specifically, when the first service is supported by the target cell, the terminal transmits a first measurement report to the source RAN node, and the first measurement report carries the measurement result of the target cell. When the first service is unsupported by the target cell, the terminal transmits a second measurement report to the source RAN node, and the second measurement report does not carry the measurement result of the target cell.

In the embodiment of the disclosure, when the first service is unsupported by the target cell, the terminal does not include the measurement result of the target cell into the measurement report and transmits the measurement report to the source RAN node. Therefore, the measurement result of the target cell may not be a reference used by the source RAN node during the cell handover, thereby avoiding handover to the target cell that does not support the first service.

It is to be noted that when the first service is unsupported by the target cell, the terminal may perform measure on the target cell, and also may not perform measure on the target cell. When the terminal performs measure on the target cell, the measurement result of the target cell is not carried in the measurement report.

Further, the terminal performs measurement on a neighbouring cell supporting the first service, and performs no measurement on a neighbouring cell not supporting the first service. Therefore, the power consumption of the terminal may be saved, and further the measurement result of a neighbouring cell that does not support the first service are prevented from being reported to the source RAN node, thereby avoiding handover to the neighbouring cell that does not support the first service.

The above technical solutions of the embodiments of the disclosure are described below in detail with reference to specific application embodiments.

### Embodiment 1: The Core Network Notifies a Ran Node the Service Information

When a UE initiates a service via a source network, the UE will establish a connection to the network, for example, a Public Data Network (PDN) connectivity or Protocol Data Unit (PDU) session to the core network. The core network notifies the source RAN node the service information of the service when requesting the source RAN node to establish the source RAN tunnel for the service, for example, via the message over an interface between the core network and the source RAN node. When the UE moves from the source RAN node to the target RAN node, the UE will report the measurement report to the source RAN node, the source RAN node determines the target RAN node based on the measurement report information. The source RAN node sends the handover request message including the service information to the target RAN node. The target RAN node judges whether to support the service indicated in the handover request message from the source RAN node, if supporting the service then responds the handover accept to the source RAN node, if not, responds the handover rejection to the source RAN node. In at least one example, the handover rejection may carry a rejection cause that the service is not supported.

Alternatively, the source RAN node can obtain the neighboring RAN node information about whether to support the service, and then determine whether to select the neighboring RAN node as the candidate target RAN node.

### Embodiment 2: UE Notifies a Source RAN Node the Service Information

When the UE establishes a service via the source RAN node, the UE may notify the source RAN node the service information via one of the following mechanisms.

Alt1: When the UE establish a service, the UE indicates to the source RAN node the service information.

Alt2: When reporting a measurement report, the UE indicates the service information in the measurement report.

Alt3: A network-side device configures a service specific measurement report event triggers to the UE, and the UE triggers the measurement report associated with the service which need to be handed over.

The network-side device performs the same operations in Embodiment 1 when performing handover. When the UE moves from the source RAN node to the target RAN node, the UE will report the measurement report to the source RAN node, the source RAN node determines the target RAN node based on the measurement report information. The source RAN node sends the handover request message including the service information to the target RAN node. The target RAN node judges whether to support the service indicated in the handover request message from the source RAN node, if supporting then responds the handover accept to the source RAN node, if not, responds the handover rejection to the source RAN node. In at least one example, the handover rejection may carry a rejection cause that the service is not supported.

Alternatively, the source RAN node can obtain the neighboring RAN node information about whether to support the service, and then determine whether to select the neighboring RAN node as the candidate target RAN node.

### Embodiment 3: UE Determines the Candidate Target RAN Node/Cell

The UE performs measurement when a cell satisfies a measurement event. The UE further checks whether the cell supports the ongoing service, if the cell supports the ongoing service, the UE includes the cell in the measurement report to the source RAN node, if the cell does not support the ongoing service, the UE does not include the cell. The methods for checking by the UE are as follows.

Alt1: The source RAN node indicates to the UE the neighboring cell capability information about whether to support the service via broadcast or dedicated signaling. As an example, the neighboring cell capability information is included in measurement configuration.

Alt2: The UE does not perform measurement on the neighboring cell not supporting the ongoing service according to the indication from the source RAN node.

Alt3: When a cell satisfies the measurement event, the UE further checks whether the neighboring cell supports the ongoing service by acquiring the system information of the neighboring cell.

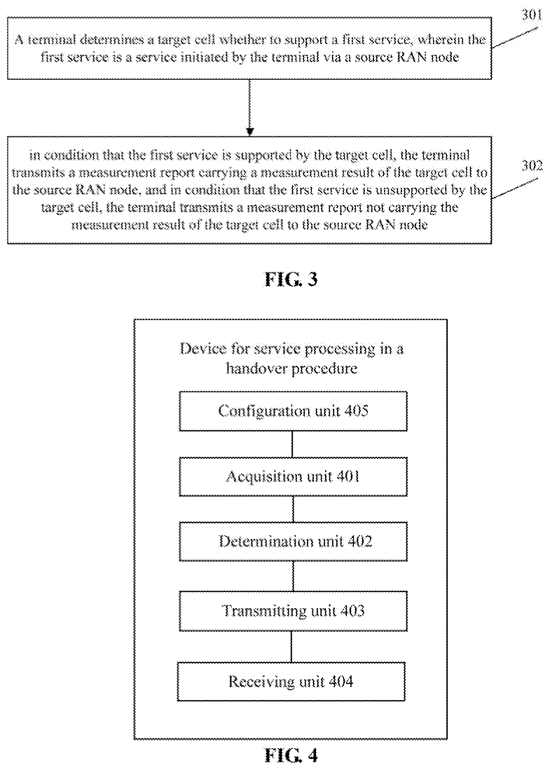

FIG. 4 is a schematic structure diagram 1 of a device for service processing in a handover procedure according to an embodiment of the disclosure. The device for service processing in a handover procedure is applied into a network device, such as a source RAN node. As illustrated in FIG. 4, the device for service processing in a handover procedure may include an acquisition unit 401, a determination unit 402 and a transmitting unit 403.

The acquisition unit 401 is configured to acquire service information of a first service. The first service is a service initiated by a terminal via a source RAN node.

The determination unit 402 is configured to determine a target RAN node.

The transmitting unit 403 is configured to transmit a handover request message to the target RAN node. The handover request message carries the service information of the first service, and the service information of the first service is configured for the target RAN node to determine whether the first service is supported.

In an implementation, the device may further include a receiving unit 404. The receiving unit 404 is configured to receive a handover acceptance message from the target RAN node, wherein the first service is supported by the target RAN node.

In an alternative implementation, the receiving unit 404 may be configured to receive a handover rejection message from the target RAN node, wherein the first service is unsupported by the target RAN node.

In an implementation, the handover rejection message may carry first indication information for indicating a rejection cause, and the rejection cause may be that the first service is unsupported by the target RAN node.

In an implementation, the acquisition unit 401 may further be configured to acquire first information of one or more neighbouring RAN nodes, wherein the first information is configured to indicate the one or more neighbouring RAN nodes whether to support the first service, and determine the neighbouring RAN nodes supporting the first service as candidate target RAN nodes.

The determination unit 402 may further be configured to select the target RAN node from the candidate target RAN nodes.

In an implementation, the acquisition unit 401 may further be configured to acquire the service information of the first service from a core network node.

In an implementation, the acquisition unit 401 may further be configured to receive a first request message from the core network node. The first request message carries the service information of the first service, and the first request message is used to request establishment of a first connection at the source RAN node for the first service.

In an implementation, the acquisition unit 401 may further be configured to acquire the service information of the first service from a terminal.

In an implementation, the acquisition unit 401 may further be configured to receive a second request message from the terminal. The second request message carries the service information of the first service, and the second request message is used to request establishment of the first service.

In an implementation, the acquisition unit 401 may further be configured to receive a measurement report sent by the terminal, and the measurement report includes the service information of the first service.

In an implementation, the device may include a configuration unit 405.

The configuration unit 405 may be to configure a service-specific measurement report event for the terminal.

The acquisition unit 401 may further be configured to receive a service-specific measurement report sent by the terminal, and the service-specific measurement report is associated with the first service required to be handed over.

It is to be understood that in the embodiments of the disclosure, the description on the device for service processing in a handover procedure may be understood with reference to the above related description on the method for service processing in a handover procedure.

FIG. 5 is a schematic structure diagram 2 of a device for service processing in a handover procedure according to an embodiment of the disclosure. The device for service processing in a handover procedure is applied into a terminal. As illustrated in FIG. 5, the device for service processing in a handover procedure may include a determination unit 501 and a transmitting unit 502.

The determination unit 501 is configured to determine a target cell whether to support a first service. The first service is a service initiated by the terminal via a source RAN node.

The transmitting unit 502 is configured to transmit, in condition that the first service is supported by the target cell, a first measurement report to the source RAN node, and transmit, in condition that the first service is unsupported by the target cell, a second measurement report to the source RAN node. The first measurement report carries a measurement result of the target cell. The second measurement report does not carry the measurement result of the target cell.

In an implementation, the determination unit 501 may further be configured to determine whether the target cell satisfies a measurement event, and determine the target cell whether to support the first service responsive to determining that the target cell satisfies the measurement event.

In an implementation, the device may include a receiving unit 503. The receiving unit 503 may be configured to receive second information from the source RAN node. The second information is configured to indicate one or more neighbouring cells whether to support the first service, and the one or more neighbouring cells include the target cell.

In an implementation, the second information may be carried in a broadcast message or dedicated signaling.

In an implementation, the device may include an acquisition unit 504. The acquisition unit 504 may be configured to acquire system information of one or more neighbouring cells, and determine the one or more neighbouring cells whether to support the first service based on the system information of the one or more neighbouring cells. The one or more neighbouring cells include the target cell.

In an implementation, the device may include a measurement unit 505. The measurement unit 505 may be configured to perform measurement on a neighbouring cell supporting the first service, and perform no measurement on a neighbouring cell not supporting the first service.

It is to be understood that in the embodiments of the disclosure, the description on the device for service processing in a handover procedure may be understood with reference to the above related description on the method for service processing in a handover procedure.

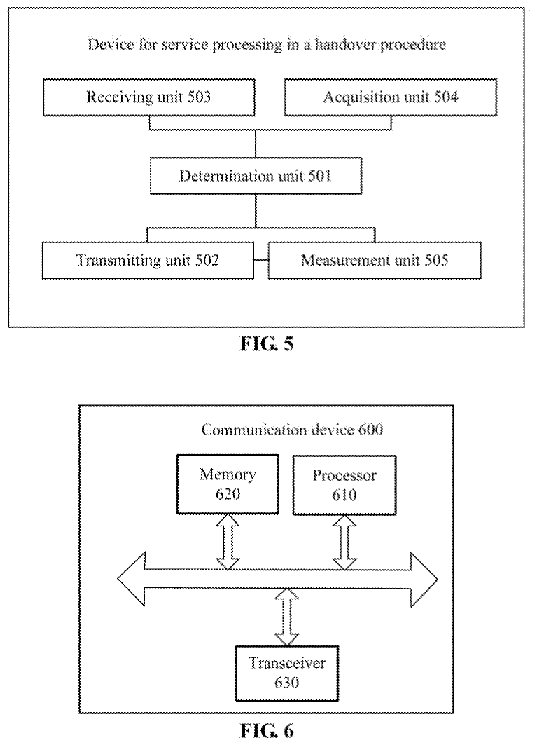

FIG. 6 is a schematic structure diagram of a communication device 600 according to an embodiment of the disclosure. The communication device may be a terminal, and may also be a network device. As illustrated in FIG. 6, the communication device 600 includes a processor 610. The processor 610 may call and execute the computer programs in a memory to execute the method in the embodiments of the disclosure.

In at least one embodiment, as illustrated in FIG. 6, the communication device 600 may further include a memory 620. The processor 610 may call and execute the computer programs in the memory 620 to execute the method in the embodiments of the disclosure.

The memory 620 may be a separate device from the processor 610, and may also be integrated into the processor 610.

In at least one embodiment, as illustrated in FIG. 6, the communication device 600 may further include a transceiver 630. The processor 610 may control the transceiver 630 to communicate with another device. Specifically, the processor 610 may control the transceiver 630 to send information or data to another device, or receive information or data from another device.

The transceiver 630 may include a transmitter and a receiver. The transceiver 630 may further include one or more antennas.

In at least one embodiment, the communication device 600 may specifically be the network device in the embodiments of the disclosure. The communication device 600 may implement a corresponding process implemented by the network device in each method embodiment of the disclosure, which will not be elaborated herein for brief description.

In at least one embodiment, the communication device 600 may specifically be the terminal/mobile terminal in the embodiments of the disclosure. The communication device 600 may implement a corresponding process implemented by the terminal mobile terminal in each method embodiment of the disclosure, which will not be elaborated herein for brief description.

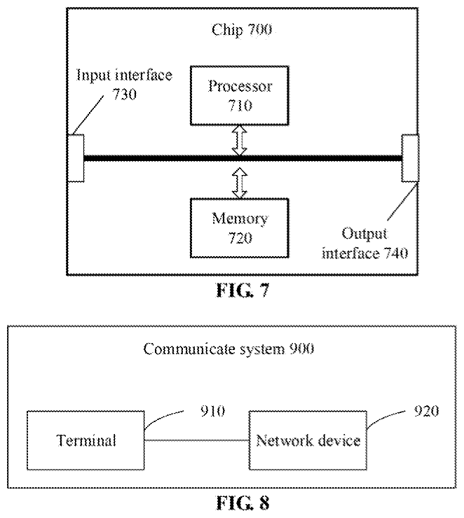

FIG. 7 is a schematic structure diagram of a chip according to an embodiment of the disclosure. As illustrated in FIG. 7, the chip 700 includes a processor 710. The processor 710 may call and execute the computer programs in a memory to execute the method in the embodiments of the disclosure.

In at least one embodiment, as illustrated in FIG. 7, the chip 700 may further include a memory 720. The processor 710 may call and execute the computer programs in the memory 720 to execute the method in the embodiments of the disclosure.

The memory 720 may be a separate device from the processor 710, and may also be integrated into the processor 710.

In at least one embodiment, the chip 700 may further include an input interface 730. The processor 710 may control the input interface 730 to communicate with another device or chip. Specifically, the processor 710 may control the input interface 730 to obtain information or data from another device or chip.

In at least one embodiment, the chip 700 may further include an output interface 740. The processor 710 may control the output interface 740 to communicate with another device or chip. Specifically, the processor 710 may control the output interface 740 to send information or data to another device or chip.

In at least one embodiment, the chip may be applied to the network device in the embodiments of the disclosure. The chip may implement a corresponding process implemented by the network device in each method embodiment of the disclosure, which will not be elaborated herein for brief description.

In at least one embodiment, the chip may be applied to the terminal/mobile terminal in the embodiments of the disclosure. The chip may implement a corresponding process implemented by the terminal/mobile terminal in each method embodiment of the disclosure, which will not be elaborated herein for brief description.

It is to be understood that in the embodiments of the disclosure, the chip may also be referred to as a system level chip, a system chip, a chip system or a system-on-chip.

FIG. 8 is a schematic structure diagram of a communication system 900 according to an embodiment of the disclosure. As illustrated in FIG. 8, the communication system 900 includes a terminal 910 and a network device 920.

The terminal 910 may implement the corresponding functions implemented by the terminal in the above methods of the disclosure, and the network device 920 may implement the corresponding functions implemented by the network device in the above methods of the disclosure. Details will not be elaborated herein for brief description.

It is to be understood that in the embodiments of the disclosure, the processor may be an integrated circuit chip with a signal processing capability. In an implementation process, each operation of the method embodiments may be completed by an integrated logical circuit of hardware in the processor or an instruction in a software form. The processor may be a universal processor, a Digital Signal Processor (DSP), an Application Specific Integrated Circuit (ASIC), a Field Programmable Gate Array (FPGA) or another programmable logical device, discrete gate or transistor logical device and discrete hardware component. Each method, step and logical block diagram disclosed in the embodiments of the disclosure may be implemented or executed. The universal processor may be a microprocessor or the processor may also be any related processor and the like. The operations of the methods disclosed in combination with the embodiments of the disclosure may be directly embodied to be executed and completed by a hardware decoding processor, or executed and completed by a combination of hardware and software modules in the decoding processor. The software module may be located in a mature storage medium in the art, such as a Random Access Memory (RAM), a flash memory, a Read-Only Memory (ROM), a Programmable ROM (PROM), an Electrically Erasable PROM (EEPROM) or a register. The storage medium is located in the memory. The processor reads information in the memory, and completes the operations of the above methods in combination with hardware of the processor.

It may be understood that the memory in the embodiment of the disclosure may be a volatile memory or a non-volatile memory, or may include the volatile memory and the non-volatile memory. The non-volatile memory may be an ROM, a PROM, an Erasable PROM (EPROM), an EEPROM or a flash memory. The volatile memory may be an RAM and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory of the system and the method described in the disclosure is intended to include but not limited to memories of these and any other suitable type.

The embodiments of the disclosure also provide a computer-readable storage medium for storing one or more computer programs.

In at least one embodiment, the computer-readable storage medium may be applied in the network device of the embodiments of the disclosure. The computer programs may enable a processor to perform the corresponding process implemented by the network device in each method embodiment of the disclosure, which will not be elaborated herein for brief description.

In at least one example, the computer-readable storage medium may be applied in the terminal/mobile terminal of the embodiments of the disclosure. The computer programs may enable a processor to perform the corresponding process implemented by the terminal/mobile terminal in each method embodiment of the disclosure, which will not be elaborated herein for brief description.

The embodiments of the disclosure also provide a computer program product. The computer program product includes one or more computer program instructions.

In at least one embodiment, the computer program product may be applied in the network device of the embodiments of the disclosure. The computer program instructions may enable a processor to perform the corresponding process implemented by the network device in each method embodiment of the disclosure, which will not be elaborated herein for brief description.

In at least one example, the computer program product may be applied in the terminal/mobile terminal of the embodiments of the disclosure. The computer program instructions may enable a processor to perform the corresponding process implemented by the terminal/mobile terminal in each method embodiment of the disclosure, which will not be elaborated herein for brief description.

The embodiments of the disclosure also provide a computer program.

In at least one embodiment, the computer program may be applied in the network device of the embodiments of the disclosure. The computer program, when executed by a processor, enables a processor to perform the corresponding process implemented by the network device in each method embodiment of the disclosure, which will not be elaborated herein for brief description.

In at least one example, the computer program may be applied in the terminal/mobile terminal of the embodiments of the disclosure. The computer program, when executed by a processor, enables a processor to perform the corresponding process implemented by the terminal/mobile terminal in each method embodiment of the disclosure, which will not be elaborated herein for brief description.

Those of ordinary skill in the an may realize that the units and algorithm operations of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working processes of the system, device and unit described above may refer to the corresponding processes in the method embodiment and will not be elaborated herein for convenient and brief description.

In some embodiments provided by the disclosure, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the operations of the method in each embodiment of the disclosure. The abovementioned storage medium includes: various media capable of storing program codes such as a U disk, a mobile hard disk, a ROM, a RAM, a magnetic disk or an optical disk.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for service processing in a handover procedure, comprising:
acquiring, by a source Radio Access Network (RAN) node, service information of a first service, the first service being a service initiated by a terminal via the source RAN node; and
determining, by the source RAN node, a target RAN node, and transmitting a handover request message to the target RAN node, the handover request message carrying the service information of the first service, and the service information of the first service being configured for the target RAN node to determine whether the first service is supported.

2. The method according to claim 1, further comprising:
in condition that the first service is supported by the target RAN node, receiving, by the source RAN node, a handover acceptance message from the target RAN node.

3. The method according to claim 1, further comprising:
in condition that the first service is unsupported by the target RAN node, receiving, by the source RAN node, a handover rejection message from the target RAN node,
wherein the handover rejection message carries first indication information for indicating a rejection cause, the rejection cause being that the first service is unsupported by the target RAN node.

4. The method according to claim 1, further comprising:
acquiring, by the source RAN node, first information of one or more neighbouring RAN nodes, the first information being configured to indicate the one or more neighbouring RAN nodes whether to support the first service; and
determining, by the source RAN node, the neighbouring RAN nodes supporting the first service as candidate target RAN nodes;
wherein determining, by the source RAN node, the target RAN node comprises:
selecting, by the source RAN node, the target RAN node from the candidate target RAN nodes.

5. The method according to claim 1, wherein acquiring, by the source RAN node, the service information of the first service comprises:
receiving, by the source RAN node, a first request message from a core network node, the first request message carrying the service information of the first service, and the first request message being configured to request establishment of a first connection at the source RAN node for the first service.

6. The method according to claim 1, wherein acquiring, by the source RAN node, the service information of the first service comprises:
acquiring, by the source RAN node, the service information of the first service from the terminal.

7. The method according to claim 6, wherein acquiring, by the source RAN node, the service information of the first service from the terminal comprises:
receiving, by the source RAN node, a second request message from the terminal, the second request message carrying the service information of the first service, and the second request message being configured to request establishment of the first service.

8. The method according to claim 6, wherein acquiring, by the source RAN node, the service information of the first service from the terminal comprises:
receiving, by the source RAN node, a measurement report sent by the terminal, the measurement report comprising the service information of the first service.

9. The method according to claim 6, wherein acquiring, by the source RAN node, the service information of the first service from the terminal comprises:
configuring, by the source RAN node, a service-specific measurement report event for the terminal; and
receiving, by the source RAN node, a service-specific measurement report sent by the terminal, the service-specific measurement report being associated with the first service required to be handed over.

10. A method for service processing in a handover procedure, comprising:
determining, by a terminal, a target cell whether to support a first service, the first service being a service initiated by the terminal via a source Radio Access Network (RAN) node;
in condition that the first service is supported by the target cell, transmitting, by the terminal, a first measurement report to the source RAN node, the first measurement report carrying a measurement result of the target cell; and
in condition that the first service is unsupported by the target cell, transmitting, by the terminal, a second measurement report to the source RAN node, the second measurement report not carrying the measurement result of the target cell.

11. The method according to claim 10, further comprising:
determining, by the terminal, whether the target cell satisfies a measurement event;
wherein determining, by the terminal, the target cell whether to support the first service comprises:
determining, by the terminal, the target cell whether to support the first service responsive to determining that the target cell satisfies the measurement event.

12. The method according to claim 10, further comprising:
receiving, by the terminal, second information from the source RAN node, the second information being configured to indicate one or more neighbouring cells whether to support the first service, and the one or more neighbouring cells comprising the target cell.

13. The method according to claim 12, wherein the second information is carried in a broadcast message or dedicated signaling.

14. The method according to claim 10, further comprising:
acquiring, by the terminal, system information of one or more neighbouring cells, and determining the one or more neighbouring cells whether to support the first service based on the system information of the one or more neighbouring cells, wherein the one or more neighbouring cells comprise the target cell.

15. The method according to claim 10, further comprising:
performing, by the terminal, measurement on a neighbouring cell supporting the first service; and
performing, by the terminal, no measurement on a neighbouring cell not supporting the first service.

16. A device for service processing in a handover procedure, comprising:
a processor, configured to:
determine a target cell whether to support a first service, the first service being a service initiated by the terminal via a source Radio Access Network (RAN) node; and
control a transceiver to transmit, in condition that the first service is supported by the target cell, a first measurement report to the source RAN node, the first measurement report carrying a measurement result of the target cell, and transmit, in condition that the first service is unsupported by the target cell, a second measurement report to the source RAN node, the second measurement report not carrying the measurement result of the target cell.

17. The device according to claim 16, wherein the processor is further configured to determine whether the target cell satisfies a measurement event, and determine the target cell whether to support the first service responsive to determining that the target cell satisfies the measurement event.

18. The device according to claim 16, wherein processor is further configured to:
control the transceiver to receive second information from the source RAN node, the second information being configured to indicate one or more neighbouring cells whether to support the first service, and the one or more neighbouring cells comprising the target cell.

19. The device according to claim 16, wherein processor is further configured to:
acquire system information of one or more neighbouring cells, and determine the one or more neighbouring cells whether to support the first service based on the system information of the one or more neighbouring cells, wherein the one or more neighbouring cells comprises the target cell.

20. The device according to claim 16, wherein processor is further configured to:
perform measurement on a neighbouring cell supporting the first service, and perform no measurement on a neighbouring cell not supporting the first service.
